(19) United States
(12) Patent Application Publication
(10) Pub. No.: US 2006/0198376 A1
(43) Pub. Date: Sep. 7, 2006

(54) Communication device for IP network

(75) Inventor: Tooru Takamichi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/362,001

(22) Filed: Feb. 27, 2006

(30) Foreign Application Priority Data
Mar. 2, 2005 (JP) 2005-056748

(51) Int. Cl. H04L 12/56

(52) U.S. Cl. 370/394

(57) ABSTRACT

A communication device includes: a packet type identifying circuit for generating a traffic type T(k) indicating whether a user traffic sequence received is UDP traffic or TCP traffic; a loss rate calculation circuit for calculating the loss rate L(k) in a wireless link section of the user traffic sequence at a constant cycle; a discard judgment circuit for determining whether to discard the user traffic sequence or not based on L(k) and T(k); and a discard circuit having a function of discarding the user traffic sequence according to the signal D(k) from the discard judgment circuit, and counting the number of packets arrived during reception of the signal D(k) from the discard judgment circuit for each user traffic sequence. The counting result is readable by EMS terminals or NMS terminals.

### BACKGROUND OF THE INVENTION

1. Field of the Invention

The present invention relates to a communication device for IP networks. For example, the present invention relates to a method and a device for controlling traffic discard of a QoS (Quality of Service) class of delay high priority in a radio device of a packet transmission system.

2. Related Art

Conventionally, various developments have been carried out for packet transmission systems. For example, publication of Japanese Patent Application Laid-open No. 11-239172 (Patent Document 1) discloses art having a means for discarding communication quality request protocol packets when starting a communication link in order to utilize network resources effectively.

Further, in recent years, communication networks in which conventional line switching networks mainly for voice communications are integrated with data communication networks have been maintained. As an example, there is an IP (Internet Protocol) network such as the Internet.

As shown in FIGS. 5A and 5B, in an IP network, an IP datagram is used in the network layer of the OSI (Open Systems Interconnection) reference model, and a UDP (User Datagram Protocol) datagram or a TCP (Transmission Control Protocol) segment, which is the transport layer of the OSI reference model, is encapsulated on the payload area in the IP datagram and transferred. Whether a UDP datagram is used or a TCP segment is used is determined depending on the communication quality required by upper applications.

UDP is a protocol in which retransmission control is not performed in the transport layer between transmitting and receiving terminals. Therefore, although packets may be lost, UDP is excellent in real time properties, so it is suitable for traffic requiring real time properties such as voice communications (VOIP: voice over IP), TV phones and visual communications.

Note that data of voice communications or TV phones is not encapsulated directly on a UDP datagram but is first encapsulated with a real-time transport protocol (RTP) standardized by IETF (Internet Engineering Task Force) and is encapsulated to a UDP datagram, as shown in FIG. 5A.

RTP includes sequence numbers indicating the order of RTP packets in the header area, so it is possible to perform an order control in the counterpart communication device.

On the other hand, TCP is a protocol having a retransmission controlling function in the transport layer between transmitting and receiving terminals, having such a characteristic that packet loss is reduced due to a retransmission control. However, real time properties are degraded, so it is suitable for data communications in which request for real time properties is not high such as file downloading.

In the header area of an IP datagram, in the case of IPv4 (Internet Protocol Version 4), a protocol area indicating the encapsulated protocol type of the transport layer or the like is defined. Based on the value of the protocol area, it is possible to identify, for each IP datagram, what kind of protocol data, like a UDP datagram or a TCP segment, is encapsulated on the payload area. Similarly, it is possible to identify for each IP datagram even in IPv6 (Internet Protocol Version 6).

A router device or the like in the IP network performs a priority control for each communication quality (QoS) required by a user traffic sequence. Here, a user traffic sequence indicates a group of user packets in which the sender and the receiver are same, and continuous contents are held even in upper application layer levels encapsulated in the user packet.

QoS includes elements such as delay, discard and a bandwidth. For example, a user traffic sequence of UDP is often requested to shorten a delay, so there is often performed a delay high-priority control in which the sequence is given priority for being outputted from the router device. As for TCP, requests relating to delay are not so high, so a delay low-priority control is often performed.

As an example of a priority control relating to delay, buffers are disposed separately for a delay high-priority class and for a delay low-priority class within a router device, and for each IP datagram, the IP datagram is written on a buffer corresponding to the delay priority class based on, in the case of IPv4, the priority written on the TOS (type of service) area of the header area of the IP datagram or the protocol type written on the protocol area. Then, on the output side of the router device, reading of IP datagrams from the buffer of the delay low-priority class is stopped during a period in which IP datagrams are accumulated on the buffer of the delay high-priority class, whereby IP datagrams of the delay high-priority class are outputted preferentially. This is called a strict priority control.

As an example of a priority control considering a bandwidth as well, there is a WRR (Weighted Round Robin) method in which ratio of the numbers of IP datagrams read out from the buffer of the delay high-priority class and from the buffer of the low-priority class is set in advance, and the readout ratio of the delay high-priority class is set to be larger.

Although two kinds of QoS class, that is, a delay high-priority class and a delay low-priority class, have been described, it is possible to use three or more kinds of QoS class.

In such an IP network, as wireless access systems such as wireless LAN (Local Area Network) become faster and wider in bandwidth recently, cases of using wireless access systems as access means up to a user-network interface (UNI) of the IP network are increasing. An IP datagram storing UDP traffic or TCP traffic is transmitted from a user radio terminal to the counterpart terminal over the IP network.

In the conventional art described in Patent Document 1, VOIP is not considered. Further, the conventional art explained with reference to FIGS. 5A and 5B has the following problems.

A first problem is that in a case where a wireless access system is used as an access means for an IP network, a UDP traffic sequence which has no meaning in the upper application layer may be transferred through the IP network. Here, no meaning in the application layer means, when a user traffic sequence is operated in the application layer, voices and images cannot keep sufficient quality as file data so the user traffic sequence cannot be used in the application layer.

The reason is that a wireless access system has a number of causes of deteriorating transmission path quality such as multipath fading, so due to a bit error, there is a higher probability of causing packet loss than a wired access system although retransmission processing (ARQ: Automatic Repeat Request) in a wireless link section and error correction processing are performed.

Particularly, as for UDP, retransmission control is not performed in the transport layer, and there is no retransmission means even when packets are lost. In VoIP, when the packet loss rate becomes worse, there may be a case where voice interruption and noises are caused in the counterpart terminal so that it is intolerable to use as an application. Even in image communications, there may be a case where flickers in screen and noises are caused so that it is intolerable to use as an image application.

As described above, when UDP traffic having no meaning in the application layer is transferred through the IP network, the effective network band utilization factor decreases. Even though a transmission path quality degraded period for each user traffic sequence is short, UDP traffic having no meaning in the application layer is inputted by a plurality of users in an IP network accommodating a number of uses, so a decrease in the effective network band utilization factor cannot be ignored.

Further, since a priority control in which UDP is set as a delay high-priority class and TCP is set as a delay low-priority class is performed generally, if the ratio of the UDP traffic is large in the IP network, there is caused a phenomenon that throughput of TCP traffic decreases.

In recent years, UDP traffic is increasing due to a widespread of VoIP and the like. Along with it, throughput of TCP traffic may decrease. A decrease in throughput of TCP traffic caused due to UDP traffic having no meaning in the application layer will interrupt an improvement in traffic efficiency of an IP network.

A second problem is that if charging relative to the amount of IP datagrams under a pay per packet system is adopted when a wireless access system is used as an access means of an IP network, there may be a case where the charged amount to a user increases during the wireless link quality being degraded (Here, the pay per packet system is defined as, among many types of pay-as-you-go systems, a method of charging for a packet).

The reason is that TCP timeout may be cased due to loss of IP datagrams in a wireless link section, same as the first problem. In the case of timeout, a user has to transmit the TCP traffic again including TCP segments which have been transmitted correctly to the counterpart terminal, so the number of transmission packets increases. If charging under the pay per packet system is performed relative to the end-to-end transmission amount of IP datagrams between the transmission and reception terminals, the charged amount to a user that the wireless link quality is degraded increases. Even for UDP traffic, a user often recognizes quality degradation in the application layer and tries transmission again. This is disadvantageous for users.

Further, even in a case where charging under the pay per packet system is performed relative to the amount of IP datagrams in a wireless link section, the number of retransmitted datagrams increases due to retransmission by ARQ in a wireless link section besides retransmission by TCP. Therefore, the charged amount increases.

### SUMMARY OF THE INVENTION

It is therefore an object of the present invention to provide a transmission system capable of, in an IP network where a wireless access system is used as an access means, suppressing a flow of user traffic having no meaning in the application layer into the IP network, and in a pay per packet system, suppressing the charged amount to a user caused by packet retransmission in association with degrading of the wireless link quality.

In order to achieve the object mentioned above, the present invention is a communication device for an IP network, provided in the IP network using a wireless link as an access means, which receives a radio signal from a user side radio terminal. The device comprises: a packet type identifying circuit for identifying a user traffic sequence of the IP datagram received, and outputting a traffic type showing the protocol type of the transport layer; a loss rate calculation circuit for calculating the IP datagram loss rate in a wireless link section of the user traffic sequence at a constant cycle; a discard judgment circuit for determining whether to discard the user traffic sequence or not based on the loss rate; and a discard circuit having a function of discarding the user traffic sequence in accordance with a signal from the discard judgment circuit and counting the number of IP datagrams arrived during reception of the signal from the discard judgment circuit for each user traffic sequence. The count result is readable by an EMS (Element Management System) terminal or an NMS (Network Management System) terminal.

[Action]

In the packet type identifying circuit, a user traffic sequence is identified from the header area of the IP datagram received, and the user traffic sequence number k thereof (k is any positive integer not more than the maximum number of user traffic sequences capable of being processed by the communication device) is outputted, and also the traffic type T(k) showing whether it is UDP traffic or TCP traffic is outputted. In the loss rate calculation circuit, based on the user traffic sequence number k outputted from the packet identifying circuit and the sequence number SQN(k) transferred from a user terminal by using the radio header of a wireless link section, the IP datagram loss rate L(k) in the wireless link section is calculated for each user traffic sequence at a constant cycle Tmax. Here, Tmax is a cycle for calculating the IP datagram loss rate L(k), which is set in advance. Note that SQN(k) is a number which is incremented by one for each IP datagram for each user traffic sequence k. In the discard judgment circuit, each time a user traffic sequence k arrives, it is judged whether the loss rate L(k) is degraded from the threshold set in advance, and if degraded, a discard instruction signal D(k)=“01” is outputted if the traffic type T(k) is UDP, and if the loss rate L(k) is not degraded from the threshold, a discard instruction signal D(k)=“00” is outputted. If the traffic type T(k) is TCP and the loss rate L(k) is degraded from the threshold set in advance, a signal D(k)=“10” is outputted, and if the loss rate L(k) is not degraded from the threshold, a signal D(k)=“00” is outputted, In the discard circuit, based on the signal D(k) for each user traffic sequence, the IP datagram is discarded if D(k)=“01” and pass processing is performed if D(k)=“00” or “10”.

Thereby, if the UDP traffic loss rate L(k) calculated for each constant unit time Tmax is degraded from the threshold set in advance, the UDP traffic is discarded. Therefore, it is possible to suppress transfer within the IP network of an UDP traffic sequence which does not have meaning in the application layer. When the L(k) is improved to be less than the threshold, discard of the IP datagram is canceled immediately, and transmission to the IP network is resumed.

Further, in the discard circuit, the number of IP datagrams discarded during reception of the signal D(k)=“01” and the number of IP datagrams passed during reception of the signal D(k)=“10” are counted for each user traffic sequence, which are read out by an EMS terminal or an NMS terminal, and the readout count result is reflected in charging processing so as to perform discount processing for the number of IP datagrams during reception of D(k)=“01” or D(k)=“10”. Thereby, it is possible to reduce disadvantages in charging that a user is suffered due to degradation of the wireless link quality.

### EFFECTS OF THE INVENTION

According to the present invention, in an IP network using a wireless access system as an access means, there is achieved an effect that a flow of user traffic having no meaning in the application layer into the IP network can be decreased.

Thereby, the useless traffic amount transferred to the IP network is suppressed, so it is possible to prevent effective availability of the network bandwidth from being reduced. As a result, throughput of each user is improved. For a user whose wireless link quality is degraded, IP datagrams are discarded, so no voice is caused in VoIP or images are interrupted in image communications in the discard section. However, discard is performed only for a section where it is predicted that interruption of voices or noises are caused frequently or image distortions are large so it is no meaning in the application layer. Therefore, no demerit will be caused, substantially. In contrast, for the user, the network efficiency will be improved due to a discard control to other users, whereby there is a merit that an improvement in throughput can be expected when the wireless link quality is high.

In recent years, UDP traffic of delay high propriety such as VoIP and image transmission increases, particularly. As the traffic amount of the delay high-priority class increases, throughput of the delay low-priority class does not increase due to a preference control performed by a router device or the like, and together with a rate control and a time out function of TCP, throughput of TCP traffic does not increase particularly. In the present invention, it is possible to suppress a flow of useless traffic into an IP network, and to reduce the total amount of traffic in the IP network, in particular, the UDP traffic ratio. Thereby, throughput of a user transmitting and receiving TCP traffic can be improved. Further, for communication network providers, there is an effect that throughput of a network can be improved without capital investments such as addition of router devices in the IP network and wider broadband of transmission lines.

Further, by counting the number of IP datagrams during the wireless link quality being degraded, there is an effect that the charged amount during the wireless link quality being degraded is adjusted in the pay per packet system. Thereby, users have a merit of expecting suppression in communication expenses. Further, communication network providers also have a merit of attracting contracting users easily by including the merit in the service policy.

### BRIEF DESCRIPTION OF THE DRAWINGS

FIG. 1 is a block diagram showing the configuration of a communication device having a delay high-priority traffic discarding function according to a first embodiment of the present invention;

FIG. 2 is a flowchart showing an exemplary processing flow for calculating the loss rate L(k) of a user traffic sequence k in the loss rate calculation circuit of FIG. 1;

FIG. 3 is a flowchart showing an exemplary processing flow for determining discard or passage of the user traffic sequence k in the discard determining circuit of FIG. 1;

FIG. 4 is a block diagram showing a second configuration example of a communication device having a delay high-priority traffic discarding function according to the embodiment of the present invention;

FIGS. 5A and 5B are illustrations showing protocol stacks of UDP traffic and TCP traffic of an IP network;

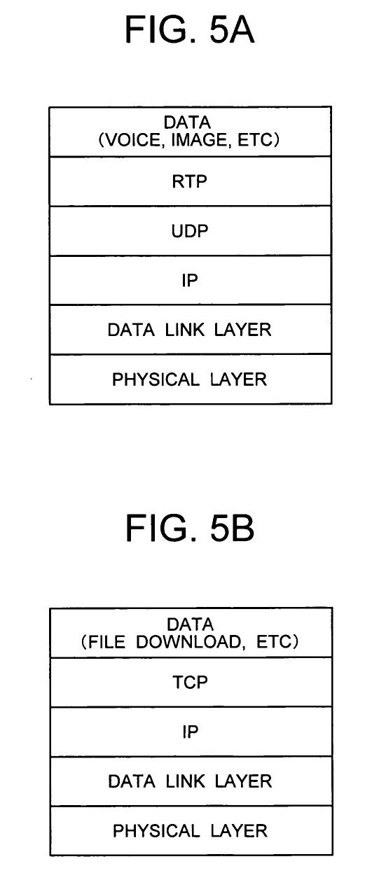

FIG. 6 is an illustration showing the packet format of an RTP packet; and

FIG. 7 is an illustration showing the format of a TCP segment.

### DETAILED DESCRIPTION OF PREFERRED EMBODIMENTS

Hereinafter, an embodiment of the present invention will be explained in detail with reference to drawings.

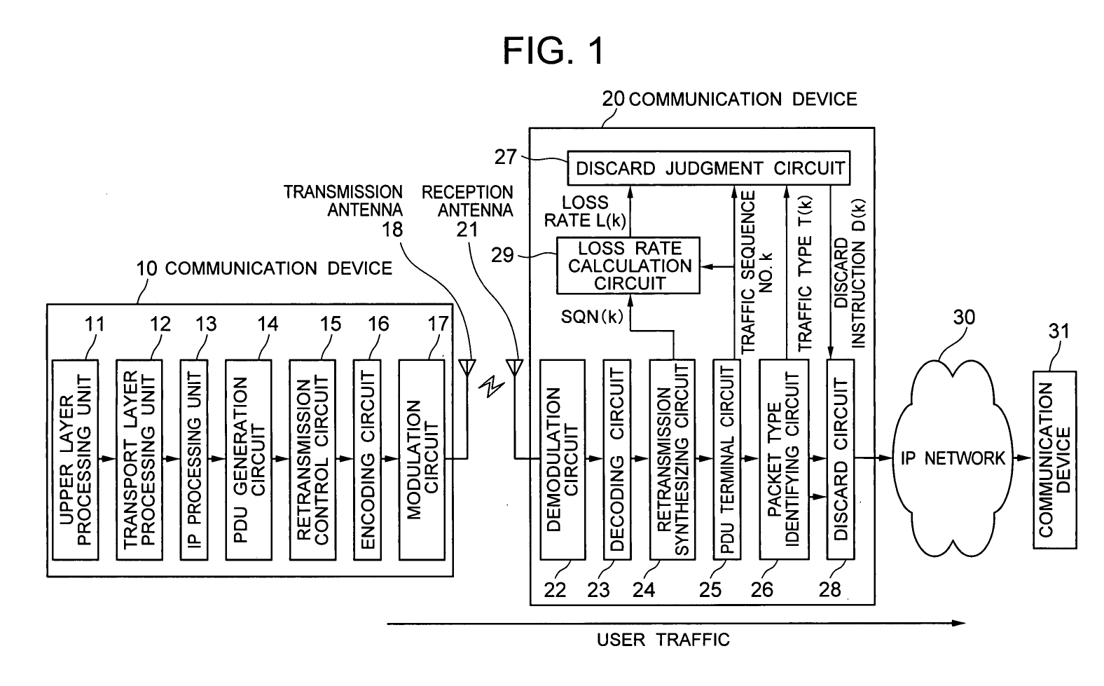

FIG. 1 is a block diagram showing the configuration of a communication device which discards a user traffic sequence of a delay high-priority class when the wireless link quality is degraded.

In FIG. 1, a communication device 20 of an embodiment of the present invention is configured to include a reception antenna 21, a demodulation circuit 22, a decoding circuit 23, a retransmission synthesizing circuit 24, a PDU terminal circuit 25, a packet type identifying circuit 26, a loss rate calculation circuit 29, a discard judgment circuit 27, and a discard circuit 28.

The PDU terminal circuit 25 has a function of outputting a sequence number SQN(k) (k is any positive integer not more than the maximum number of user traffic sequences capable of being processed by the communication device 20), transmitted from a counterpart radio terminal 10 by using an free area within the radio header of the wireless link, to the loss rate calculation circuit 29. The packet type identifying circuit 26 has functions of outputting the user traffic sequence number k for each IP datagram to the loss rate calculation circuit 29, the discard judgment circuit 27 and the discard circuit 28, outputting the traffic type T(k) to the discard judgment circuit 27, and outputting the IP datagram to the discard circuit 28. The discard judgment circuit 27 has a function of outputting a discard instruction signal D(k) to the discard circuit 28.

The communication device 20 receives a radio signal from a communication device 10 which is a user side terminal, and outputs a demodulated IP datagram to the IP network 30. It is assumed that the IP network 30 is connected with a communication device 31, and transmission and reception of user traffic sequences are performed between the communication device 10 and the communication device 31. The transmitting direction of user traffic sequences is a direction from the communication device 10 to the communication device 31, which is called an upload direction.

The communication device 10 is configured to include an upper layer processing unit 11, a transport layer processing unit 12, an IP processing unit 13, a PDU generation circuit 14, a retransmission control circuit 15, an encoding circuit 16, a modulation circuit 17, and a transmission antenna 18. Further, although not shown in FIG. 1, the communication device 20 includes a transmission means and the communication device 10 includes a reception means, so communications can be performed from the communication device 20 to the communication device 10 as well. This is defined as a download direction.

Although the configuration of the embodiment is described in detail above, the detailed configurations of the upper layer processing unit 11, the transport layer processing unit 12, the IP processing unit 13, the PDU generation circuit 14, the retransmission control circuit 15, the modulation circuit 17, the demodulation circuit 22, the decoding circuit 23, the retransmission synthesizing circuit 24, and the PDU terminal circuit 25 in FIG. 1 are determined depending on each type of a wireless access system such as a wireless LAN, which are well-known to those skilled in the art and are not relating to the present invention directly. Therefore, the detailed configurations are omitted.

[Description of Operation]

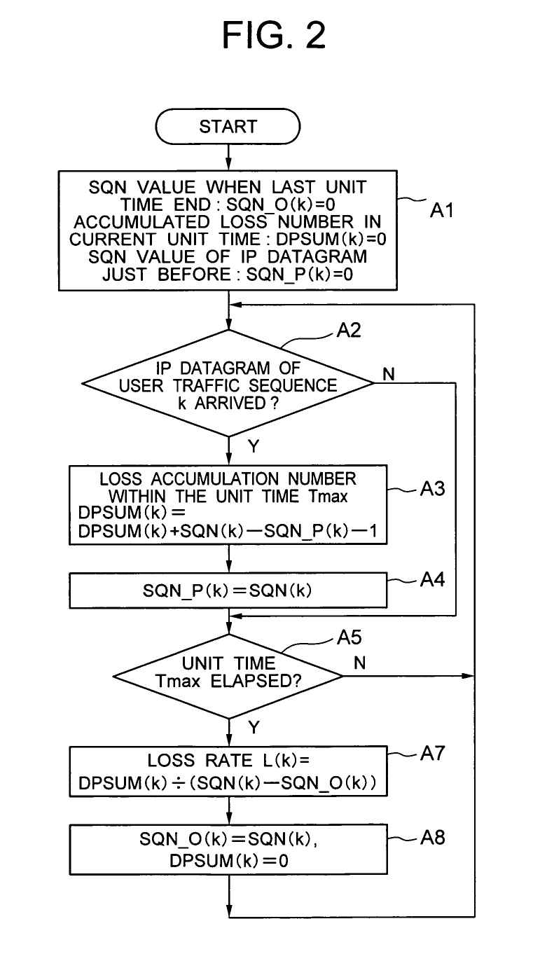

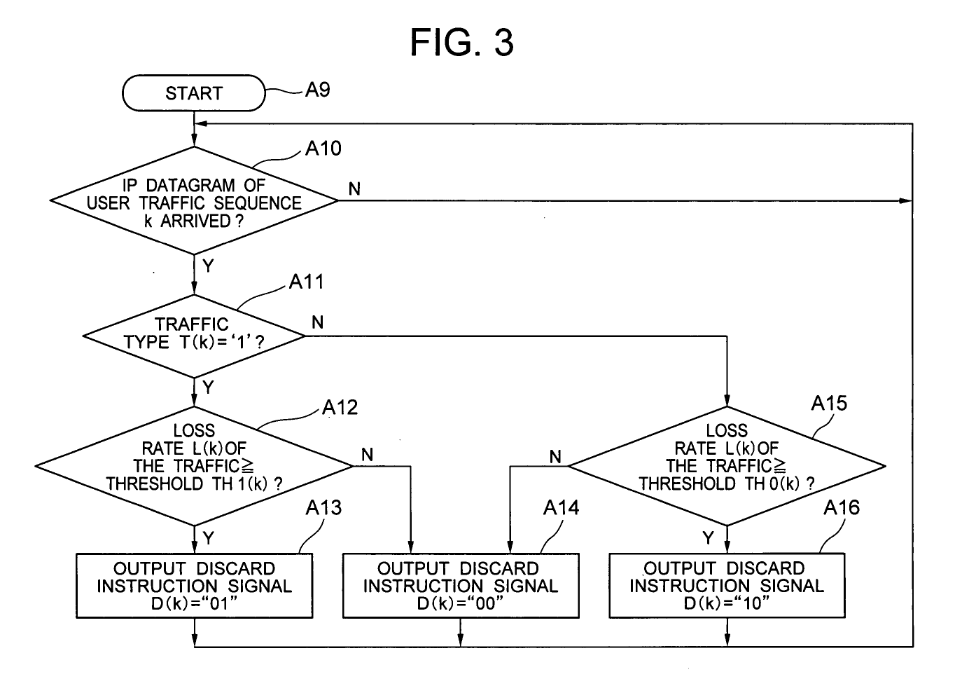

Next, operation of FIG. 1 will be explained in detail with reference to FIGS. 2 and 3.

The communication device 10 is a conventional user terminal having a wireless access function.

The upper layer processing unit 11 has a function of an application layer such as VoIP, a TV phone, and WWW (World Wide Web). Application data outputted from the upper layer processing unit 11 is inputted to the transport layer processing unit 12, and an application requiring real time properties is first encapsulated to RTP as a delay high-priority class, and then encapsulated to a UDP datagram. On the other hand, an application not requiring real time properties much is encapsulated to a TCP segment. Further, rate control and retransmission control of TCP are also performed by the transport layer processing unit 12. The IP processing unit 13 adds an IP header to the output of the transport layer processing unit 12 by applications and by destinations, and encapsulates it to an IP datagram. The user traffic sequence outputted from the IP processing unit 13 is inputted into the PDU generation circuit 14.

The PDU generation circuit shapes an inputted signal into a PDU (Protocol Data Unit) for wireless transmission. The PDU size and the format are defined for each wireless LAN (Local Area Network) or other wireless access system. The output is inputted into the retransmission control circuit 15.

The retransmission control circuit 15 performs retransmission (ARQ) processing of a PDU based on ACK/NACK (Acknowledgement/Non-Acknowledgement) information for each PDU transmitted from the communication device 20 through a line of the download direction. The output is inputted into the encoding circuit 16, and error correction encoding processing and puncture processing are performed. Further, the output therefrom is inputted into the modulation circuit 17. The modulation circuit 17 performs baseband processing such as generation of a radio frame and addition of a radio header area thereof, and wireless modulation processing such as RF processing. Formats of a radio frame and a radio header are determined based on a wireless access system. Information from the modulation circuit 17 is transmitted from the transmission antenna 18.

The communication device 20 receives signals from the communication device 10 by the reception antenna 21. The demodulation circuit 22, the decoding circuit 23, the retransmission synthesizing circuit 24, and the PDU terminal circuit 25 are conventional wireless receiving functions determined for each wireless access system, and the demodulation circuit 22 demodulates RF signals to baseband signals. The decoding circuit 23 performs depuncture processing and error correction decoding processing to the outputs of the demodulation circuit 22.

Besides outputting a PDU, the decoding circuit 23 also outputs ACK/NACK information indicating whether decoding has been performed correctly for each PDU. They are inputted in the retransmission synthesizing circuit 24 and saved in the memory, and if a PDU not decoded correctly is retransmitted from the communication device 10 and received correctly, retransmission synthesizing processing (ARQ) for replacing it with a PDU having been stored on the memory is performed, and data which is reproduced correctly is transferred to the PDU terminal circuit 25. In the PDU terminal circuit 25, the PDU is terminated and an IP datagram is taken out and transmitted to the packet type identifying circuit 26.

Note that the ACK/NACK information outputted from the decoding circuit 23 is notified to the retransmission control circuit 15 of the communication device 10 through a line of the download direction, and is used for retransmission control.

Along with retransmission processing, the order of the IP datagrams may be changed within a user traffic sequence received by the communication device 20. However, it is preferable that the order is not changed particularly in UDP traffic. In the PDU terminal circuit 25, order control for restoring the order of the IP datagrams by changing the order within the same user traffic sequence is performed.

Therefore, in the PDU generation circuit 14 of the communication device 10, a sequence number SQN which is incremented by one sequentially is added to an IP datagram for each user traffic sequence, and the number is transmitted by using a radio header.

In the PDU terminal circuit 25, the SQN value is extracted from the radio header, and the order of the IP datagrams of the same user traffic sequence is changed so as to be in the SQN order. Then, the sequence number of the user traffic sequence k is outputted as SQN(k) to the loss rate calculation circuit.

The PDU generation circuit 14 of the communication device 10 performs addition of the sequence number SQN(k), and the PDU terminal circuit 25 of the communication device 20 outputs the SQN(k). The SQN(k) value is used only between the communication device 10 and the communication device 20, and the PDU terminal circuit 25 does not output to the IP datagram in parallel, and does not output to the IP network 30, either.

Assuming that the maximum value of the SQN(k) is SQNmax(k), when it is counted up to the maximum value, the value is returned to 0 so as to be circulated. The maximum value SQNmax(k) can be unified through all user traffic sequences, or can be different value for each user traffic sequence.

Each time an IP datagram is inputted, the packet type identifying circuit 26 identifies the user traffic sequence from, in the case of IPv4, destination address of the IP header, source address, information of TOS (Type of Service) area and protocol area. Even in the case of IPv6, it is possible to identify the user traffic sequence from the IP header. In the case of the k^{th} user traffic sequence, the user traffic sequence number k is outputted to the loss rate calculation circuit 29, the discard judgment circuit 27 and the discard circuit 28.

Note that the user traffic sequence number is a number allocated to each user traffic sequence, and it may be allocated automatically on the communication device 20 side when starting communication of the user traffic sequence or allocated by provisioning setting.

Further, the packet type identifying circuit 26 identifies the transport layer protocol from the protocol area in the case of IPv4, or from the traffic class area or the flow label area in the case of IPv6, by using the IP header area, and outputs a traffic type T(k)=‘1’ to the discard judgment circuit 27 if the protocol is UDP, and outputs T(k)=‘0’ if the protocol is TCP. At this time, in the case of a user traffic sequence where discard is not desired when the loss rate L(k) described later is degraded even if the protocol is UDP, provisioning setting may be performed to the packet type identifying circuit 26 so as to output T(k)=‘0’. In contrast, in the case of a user traffic sequence where it can be discarded when the loss rate L(k) is degraded even if the protocol is TCP, setting for outputting T(k)=‘1’ may be performed. The packet type identifying circuit 26 outputs the IP datagram to the discard circuit 28.

The loss rate calculation circuit 29 calculates the IP datagram loss rate L(k) within a wireless link section by a constant unit time Tmax for each user traffic sequence. An example of the operation is shown in FIG. 2.

FIG. 2 is a process flow showing a loss rate calculation method of a user traffic sequence k. In order to cope with a plurality of user traffic sequences by the communication device 20, the process flow in FIG. 2 is prepared for the number of user traffic sequences. The loss rate is calculated for each unit time Tmax. Here, a unit time Tmax indicates a time interval for calculating the IP datagram loss rate L(k) at a constant cycle so as to perform discard or marking, and the value is defined and set in advance. The Tmax value may have a long cycle of not less than one second, but in order to judge passage/discard/marking in detail, a shorter value is preferable. If it is possible to judge from the small number of IP datagrams that the user traffic sequence k has been lost to be in a level it has no meaning in the application layer, a short cycle of about several times of IP datagram length is acceptable.

It is assumed that the SQN(k) value when the last unit time ends is SQN_O(k), the accumulated value of IP datagram loss number within the current unit time is DPSUM(k) pieces, the SQN value of the IP datagram arrived just before is SQN_P(k).

First, SQN_O(k)=‘0’, DPSUM(k)=‘0’, SQN_P(k)=‘0’, are set (step A1 in FIG. 2).

Next, from the user traffic sequence number of the packet type identifying circuit 26, if arrival of k^{th} user traffic sequence is detected (Y in step A2 in FIG. 2), the IP datagram loss accumulated number DPSUM(k) of the user traffic sequence k within the unit time Tmax is calculated by
DPSUM(k)=DPSUM(k)+SQN(k)−SQN_{—}P(k)−1
(step A3 in FIG. 2).

From SQN(k)−SQN_P(k)−1, the number of loss of IP datagrams during a period from the time the IP datagram is received just before to the current time is calculated, and the cumulative sum thereof is DPSUM(k). However, SQN(k) is defined by the limited bit length, so when the maximum value SQNmax(k) is attained, the value returns to ‘0’. The number or loss at that time is SQN(k)+SQNmax(k)−SQN_P(k)−1, so the consideration is also required for the above-mentioned equation. Therefore,
DPSUM(k)=DPSUM(k)+SQN(k)+SQNmax(k)−SQN_P(k)−1
is established.

Note that SQNmax(k) is set in the loss rate calculation circuit 29 in advance.

Next, the SQN_P(k) value is updated to the SQN(k) value (step A4 in FIG. 2), and when the next IP datagram arrives, the current SQN(k) value is used as the SQN_P(k) value.

Then, it is checked whether a unit time Tmax has elapsed (step A5 in FIG. 2). If not (N in step A5 in FIG. 2), processing is back to detection of IP datagrams of the user traffic sequence k (step A2 in FIG. 2).

If, in step A2 in FIG. 2, IP datagrams of the user traffic sequence k have not been arrived (N in step A2 in FIG. 2), it is checked whether the unit time Tmax has elapsed (step A5 in FIG. 2). If the unit time Tmax has elapsed (Y in A5 in FIG. 2), the IP datagram loss rate L(k) of the user traffic sequence k is calculated by
L (k)=DPSUM(k)/(SQN(k)−SQN_{—}O(k))
(step A7 in FIG. 2).

SQN(k)−SQN_O(k) indicates the number of IP datagrams of the user traffic sequence k transmitted from the communication device 10 during the unit time Tmax. From the ratio with the number of IP datagrams DPSUM(k) lost in a wireless link section, the loss rate L(k) during the unit time Tmax is calculated.

Then, update is performed to SQN_O(k)=SQN(k) and DPSUM(k)=0 (step A8 in FIG. 2), and the processing moves to the next unit time Tmax (step A2 in FIG. 2).

The loss rate L(k) calculated for each user traffic sequence by a unit time Tmax is inputted to the discard judgment circuit 27. Then, from it and the traffic type T(k), a discard instruction signal D(k) is generated for each user traffic sequence. An exemplary operation of the discard judgment circuit 27 is shown in FIG. 3.

FIG. 3 is a process flow showing a method of generating a discard instruction signal D(k) of a user traffic sequence k. In order to cope with a plurality of user traffic sequences in the communication device 20, the process flow of FIG. 3 should be prepared for the number of user traffic sequences.

After starting the operation (step A9 in FIG. 3), arrival of the k^{th} user traffic sequence is detected from the user traffic sequence numbers from the packet type identifying circuit 26 (Y in step A10 in FIG. 3), and the traffic type T(k) of the IP datagram is checked (All in FIG. 3). If T(k)=‘1’ (Y in step A11 in FIG. 3), when the loss rate L(k) of the user traffic sequence k is not less than a threshold TH1(k) (Y in step A12 in FIG. 3), a discard instruction signal D(k)=“01” is outputted (step A13 in FIG. 3), and when it is less than the threshold TH1(k) (N in step A12 in FIG. 3), a discard instruction signal D(k)=“00” is outputted (step A14 in FIG. 3). Then, the processing returns to a state of waiting for arrival of the next IP datagram (step A10 in FIG. 3).

On the other hand, in the case of the traffic type T(k)=‘0’ in step A11 in FIG. 3 (N in step A11 in FIG. 3), when the loss rate L(k) of the user traffic sequence k is not less than a threshold TH0(k) (Y in step A15 in FIG. 3), a discard instruction signal D(k)=“10” is outputted (A16 in FIG. 3), and when the loss rate L(k) is less than the threshold TH0(k) (N in step A15 in FIG. 3), a discard instruction signal D(k)=“00” is outputted (step A14 in FIG. 3). Then, the processing returns to a state of waiting for an arrival of the next IP datagram (step A10 in FIG. 3).

In step A10 in FIG. 3, if the IP datagram of the user traffic sequence k has not been arrived (N in step A10 in FIG. 3), the processing returns to a state of waiting for an arrival of the next IP datagram.

Note that the thresholds TH1(k) and TH0(k) are values which have been provisioning-set for each user traffic sequence in advance, and it is desirable to set the optimum value for each application. However, TH1(k) and TH0(k) may be the same value.

Next, an exemplary operation of the discard circuit 28 in FIG. 1 will be explained.

The discard circuit 28 receives a discard instruction signal D(k). If D(k)=“01”, the discard circuit 28 discards IP datagrams of the user traffic sequence number k inputted from the packet type identifying circuit 26. If D(k)=“00” or “10”, the discard circuit 28 will not discard and output them to the IP network 30.

A discard instruction signal D(k) is effective solely to the IP datagrams of the user traffic sequence number k, and in the case of another user traffic sequence j, a discard instruction signal D(j) for the user traffic sequence will be followed.

Since IP datagrams are discarded during D(k)=“01”, for a user whose wireless link quality is degraded, no voice is caused in VoIP or images are interrupted in image communications. However, discard is performed only for a section where it is predicted that L(k)=TH1(k) so interruption of voices or noises are caused frequently or image distortions are large so it is no meaning in the application layer, and when restored to L(k)<TH1(k), D(K)=“00” so discard will not occur. Therefore, no demerit will be caused substantially. In contrast, for the user, the network efficiency will be improved due to a discard control to other users, so there is a merit that an improvement in throughput can be expected when the wireless link quality is high.

Note that when D(k)=“10”, marking may be performed in the TOS area of the IP header area in the case of IPv4, or in the traffic class area or the flow label area of the IP header area in the case of IPv6, for allowing discard preferentially when the IP network 30 is congested.

Further, the discard circuit 28 has a counting counter for each user traffic sequence, and counts the number of IP datagrams of each user traffic sequence arrived when D(k)=“01” or D(k)=“10”, and the counting result can be read from EMS terminals or NMS terminals.

It is preferable that whether discard of user traffic sequences when the wireless link quality is degraded and marking will be performed or not, and the thresholds TH1(k) and TH0(k), according to the present embodiment, be defined as a service contract with a user in advance. Similarly, if a communication system is provided to a user upon charging, it is preferable to define whether changes in charging amount will be performed or not and the amount as a service contract with the user.

Note that a traffic discard control, performed by the packet type identifying circuit 26, the loss rate calculation circuit 29, the discard judgment circuit 27, and the discard circuit 28 of the present embodiment, is applicable to an access means other than a wireless link. It is also applicable in a transmission path environment using copper wires for example where loss of IP datagrams due to noises or reflection is large.

[Another Embodiment of the Invention]

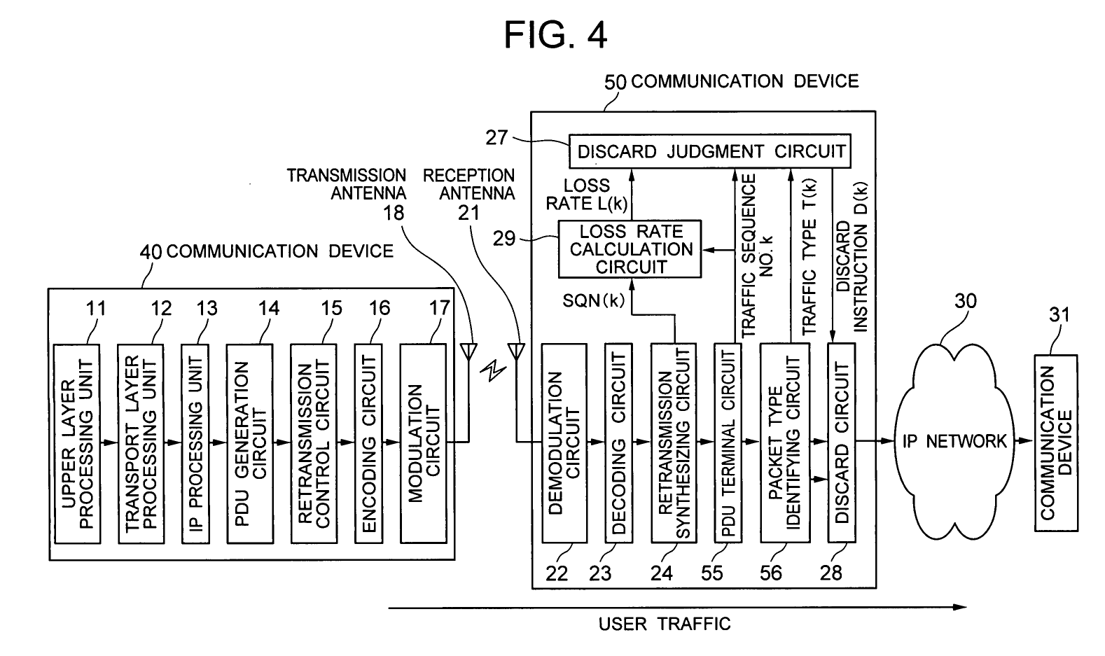

In the embodiment shown in FIG. 1, a sequence number SQN added in the PDU generation circuit 14 of the communication device 10 is used. However, a sequence number having been added to protocols of the transport layer or upper may be used without adding an SQN in the PDU generation circuit 14 of the communication device 10. In another embodiment of the present invention, the basic configuration is as described above, but a sequence number of the RTP header and a sequence number of the TCP header are used. The configuration is shown in FIG. 4.

In FIG. 4, a communication device 50 of another embodiment of the present invention is configured to include the reception antenna 21, the demodulation circuit 22, the decoding circuit 23, the retransmission synthesizing circuit 24, a PDU terminal circuit 55, a packet type identifying circuit 56, the loss rate calculation circuit 29, the discard judgment circuit 27 and the discard circuit 28.

The packet type identifying circuit 26 has functions of outputting the user traffic sequence number k for each IP datagram to the loss rate calculation circuit 29, the discard judgment circuit 27 and the discard circuit 28, and outputting the traffic type T(k) to the discard judgment circuit 27, and outputting the IP datagram to the discard circuit 28.

Further, if the protocol in an IP datagram is RTP which is encapsulated to UDP datagram or is TCP, the packet type identifying circuit 26 has a function of reading the sequence number in the RTP header or the TCP header and outputs it as SQN(k) to the loss rate calculation circuit 29.

Further, the discard judgment circuit 27 has a function of outputting a discard instruction signal D(k) to the discard circuit 28.

The communication device 50 receives a radio signal from a communication device 40 which is a user side terminal, and transmits a demodulated IP datagram to the IP network 30. The IP network 30 is connected with the communication device 31, and transmission and reception of user traffic sequences are performed between the communication device 40 which is a user terminal and the communication device 31. The transmitting direction of the user traffic sequences is a direction from the communication device 40 to the communication device 31.

The communication device 40 is so configured to include the upper layer processing unit 11, the transport layer processing unit 12, the IP processing unit 13, a PDU generation circuit 44, the retransmission control circuit 15, the encoding circuit 16, the modulation circuit 17 and the transmission antenna 18.

Further, although not shown in FIG. 4, the communication device 50 has a transmission means and the communication device 40 has a reception means even in a download direction so as to enable communication from the communication device 50 to the communication device 40.

Next, operation of the devices shown in FIG. 4 will be explained.

The communication device 40 is a conventional user terminal having a wireless access function. The upper layer processing unit 11, the transport layer processing unit 12, the IP processing unit 13, the retransmission control circuit 15, the encoding circuit 16, the modulation circuit 17 and the transmission antenna 18 are same as those shown in FIG. 1 in their configurations and functions, so the explanations are omitted.

The PDU generation circuit 44 is same as the PDU generation circuit 14 in FIG. 1 in an aspect of shaping an input signal into a PDU (Protocol Data Unit) for wireless transmission, but does not include a function of adding sequence numbers SQN to the IP datagrams of each user traffic sequence, which is held by the PDU generation circuit 14 in FIG. 1.

In the communication device 50, the reception antenna 21, the demodulation circuit 22, the decoding circuit 23, the retransmission synthesizing circuit 24, the packet type identifying circuit 26, the loss rate calculation circuit 29, the discard judgment circuit 27 and the discard circuit 28 are same as those shown in FIGS. 1, 2 and 3 in their configurations and functions, so the explanations are omitted.

The PDU terminal circuit 55 receives a PDU from the retransmission synthesizing circuit 24, terminates it and takes out an IP datagram, and transfers it to the packet type identifying circuit 56. This is the same function as that of the PDU terminal circuit 25 shown in FIG. 1. However, the PDU terminal circuit 55 does not include a function of taking out the sequence numbers SQN(k) of each user traffic sequence and transferring it to the loss rate calculation circuit 29, which is held by the PDU terminal circuit 25 in FIG. 1.

The packet type identifying circuit 56 specifies a user traffic sequence, each time an IP datagram is inputted, from destination address or source address of the IP header or information of TOS area or protocol area, in the case of IPv4. Even in the case of IPv6, it is possible to specify from the IP header. In the case of k^{th} user traffic sequence, the packet type identifying circuit 56 outputs the user traffic sequence number k to the loss rate calculation circuit 29, the discard judgment circuit 27 and the discard circuit 28. Further, the packet type identifying circuit 56 identifies a transport layer protocol from the IP header area, and outputs the traffic type T(k)=‘1’ to the discard judgment circuit 27 if the protocol is UDP, or outputs T(k)=‘0’ if the protocol is TCP. At this time, in the case of a user traffic sequence that it is not desired to be discarded even if the protocol is UDP when the loss rate L(k) is degraded as described later, the packet type identifying circuit 26 may be set to output T(k)=‘0’. In contrast, in the case of a user traffic sequence which can be discarded when the loss rate L(k) is degraded even if the protocol is TCP, it may be set to output T(k)=‘1’. Further, the packet type identifying circuit 56 outputs the IP datagram to the discard circuit 28.

The functions of the packet type identifying circuit 56 are same as those of the packet type identifying circuit 26 in FIG. 1. The packet type identifying circuit 56 in FIG. 4 further identifies whether the transport layer protocol is RTP encapsulated with UDP or is TCP, or not. This can be identified from the IP header. If it is RTP, encapsulated with UDP, or TCP, the packet type identifying circuit 56 reads out the sequence number in each header area, and outputs it as a sequence number SQN(k) to the loss rate calculation circuit 29.

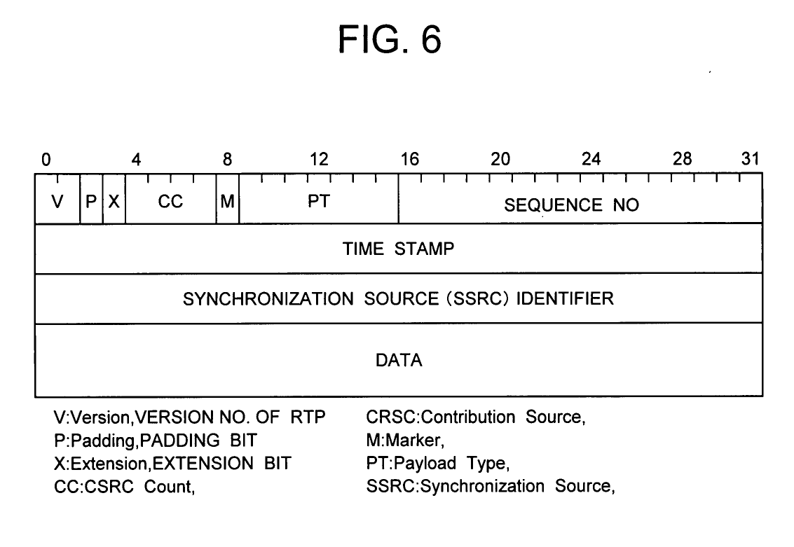

FIG. 6 shows a packet format of RTP, in which 32 bits constitutes one word, and the first word of the RTP header area includes a sequence number area of 16 bits, and the sequence number circulates in a range from 0 to 2¹⁶−1.

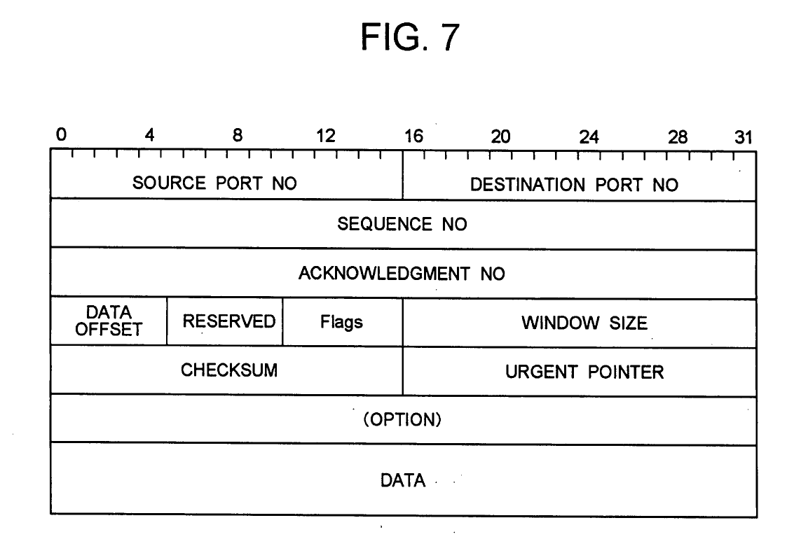

On the other hand, FIG. 7 shows a format of a TCP segment, in which 32 bits constitutes one word, and the second word of the TCP header includes a sequence number area of 32 bits, and the sequence number circulates in a range from 0 to 2³²−1.

The sequence number of RTP in FIG. 6 is a number which increments by one for each RTP packet for each user traffic sequence. The sequence number of TCP in FIG. 7 is also a number which increments by one for each TCP segment for each user traffic sequence, and is transferred end-to-end between the communication device 40 and the communication device 31 for an order control in the transport layer. Each number can be used for calculating the IP datagram loss rate L(k) in the loss rate calculation circuit 29 as an SQN(k) value.

Note that SQNmax(k)=2¹⁶−1 is set if the protocol is RTP, and SQNmax(k)=2³²−1 is set if the protocol is TCP, in advance.

As described above, the present embodiment is limited to transport layer protocols including sequence numbers originally such as RTP and TCP. However, there is no need to transfer sequence numbers SQN(k) between the PDU generation circuit 44 and the PDU terminal circuit 55 in a wireless link section, so an increase in the header area in association with addition of SQN(k) in a wireless link section can be prevented, whereby an effect of high efficiency can be achieved.

It is preferable that whether discard of user traffic sequences when the wireless link quality is degraded or marking will be performed or not, and the thresholds TH1(k) and TH0(k), according to the present embodiment, be defined as a service contract with a user in advance. Similarly, if a communication system is provided to a user upon charging, it is preferable to define whether changes in charging amount will be performed or not and the amount as a service contract with the user.

Note that a traffic discard control, performed by the packet type identifying circuit 56, the loss rate calculation circuit 29, the discard judgment circuit 27, and the discard circuit 28 of the present embodiment, is applicable to an access means other than a wireless link. It is also applicable in a transmission path environment using copper wires for example where loss of IP datagrams due to noises or reflection is large.

What is claimed is:

1. A communication device for an IP network, provided in the IP network using a wireless link as access means, which demodulates a radio signal from a user side radio terminal and transfers a demodulated IP datagram to the IP network, the device comprising:
a packet type identifying circuit for determining and outputting a user traffic sequence number k from an IP header area of an IP datagram received from the user side radio terminal, determining a protocol of a transport layer encapsulated on the IP datagram, and outputting a traffic type T(k)=‘1’ if the protocol is UDP and outputting a traffic type T(k)=‘0’ if the protocol is TCP;
a loss rate calculation circuit for calculating and outputting an IP datagram loss rate L(k) of a user traffic sequence k at a constant cycle by using a sequence number SQN(k) which is transmitted by using a radio header from a user terminal and is incremented by one for each IP datagram of a same user traffic sequence;
a discard judgment circuit for outputting a signal D(k)=“01” if the loss rate L(k) is not less than a threshold TH1(k) set in advance and outputting a signal D(k)=“00”. if the loss rate L(k) is less than the threshold TH1(k), when the user traffic sequence k inputted is traffic using UDP (T(k)=‘1’), by using L(k) outputted from the loss rate calculation circuit and T(k) outputted from the packet type identifying circuit; and
a discard circuit for passing the IP datagram of the user traffic sequence k if the signal D(k) from the discard judgment circuit is “00” and discarding the IP datagram if the signal D(k) is “01”.

2. The communication device for the IP network, as claimed in claim 1, wherein the discard circuit has a function of counting a number of IP datagrams that it has discarded by receiving the signal D(k)=“01” for each user traffic sequence, and reading out a count result from an outside.

3. The communication device for the IP network, as claimed in claim 1, wherein the discard judgment circuit has a function of outputting the signal D(k)=“00” if the loss rate L(k) is not less than a threshold TH0(k) set in advance and outputting a signal D(k)=“10” if the loss rate L(k) is less than the threshold TH0(k), when the user traffic sequence k inputted is traffic using TCP (T(k)=‘0’), and
the discard circuit has a function of passing the IP datagram of the user traffic sequence k if the signal D(k) from the discard judgment circuit is “10” or passing it after performing marking to an IP header area thereof, and setting in advance whether to pass it straightly or perform marking thereto.

4. The communication device for the IP network, as claimed in claim 3, wherein the discard circuit counts a number of IP datagrams that it has discarded by receiving the signal D(k)=“01”, and a number of IP datagrams that it has passed or passed after performing the marking by receiving the signals D(k)=“00” and D(k)=“10”, for each user traffic sequence.

5. The communication device for the IP network, as claimed in claim 1, wherein
the packet type identifying circuit has functions of: determining and outputting a user traffic sequence number k from an IP header area of an IP datagram received from the user side radio terminal; determining a protocol of a transport layer encapsulated on the IP datagram, and if the protocol is UDP, outputting the traffic type T(k)=‘1’, and if the protocol is TCP, outputting the traffic type T(k)=‘0’; and if the IP datagram uses RTP, reading a sequence number area in an RTP header thereof and outputting a sequence number as SQN(k), and if the IP datagram uses TCP, reading a sequence number area in an TCP header thereof and outputting a sequence number as SQN(k).

6. A communication method for an IP network, provided in the IP network using a wireless link as access means, for demodulating a radio signal from a user side radio terminal and transferring a demodulated IP datagram to the IP network, the method comprising:
a packet identifying step for determining a user traffic sequence number k from an IP header area of an IP datagram received from the user side radio terminal, determining a protocol of a transport layer encapsulated on the IP datagram, and if the protocol is UDP, outputting a traffic type T(k)=‘1’, and if the protocol is TCP, outputting a traffic type T(k)=0;
a loss rate calculation step for calculating an IP datagram loss rate L(k) of a user traffic sequence k at a constant cycle by using a sequence number SQN(k) which is transmitted by using a radio header from a user terminal and is incremented by one for each IP datagram of a same user traffic sequence;
a discard judgment step for, by using information of L(k) and T(k), outputting a signal D(k)=“01” if the loss rate L(k) is not less than a threshold TH1(k) set in advance and outputting a signal D(k)=“00” if the loss rate L(k) is less than the threshold TH1(k), when the user traffic sequence k inputted is traffic using UDP (T(k)=‘1’); and
a discard step for passing the IP datagram of the user traffic sequence k if the signal D(k) is “00”, but discarding the IP datagram if the D(k) is “01”.

7. The communication method for the IP network as claimed in claim 6, wherein in the discard step, a number of IP datagrams discarded since the signal D(k)=“01” is received is counted for each user traffic sequence, and a count result is read out from an outside.

8. The communication method for the IP network as claimed in claim 6, wherein in the discard judgment step, when the user traffic sequence k is traffic using TCP (T(k)=‘0’), a signal D(k)=“00” is outputted if the loss rate L(k) is not less than a threshold TH0(k) set in advance, and a signal D(k)=“10” is outputted if the loss rate L(k) is less than the threshold TH0(k), and
in the discard step, if the signal D(k) is “10”, the IP datagram of the user traffic sequence k is passed straightly or passed after marking is performed in an IP header area thereof, and whether the IP datagram is passed straightly or marking is performed is set in advance.

9. The communication method for the IP network as claimed in claim 8, wherein in the discard step, a number of IP datagrams discarded since the signal D(k)=“01” is received and a number of IP datagrams passed or passed after marking since the signals D(k)=“00” and D(k)=“10” are received are counted for each user traffic sequence.

10. The communication method for the IP network as claimed in claim 6, wherein in the packet identifying step, the user traffic sequence number k is determined and outputted from an IP header area of the IP datagram received from the user side radio terminal, a protocol of a transport layer encapsulated in the IP datagram is determined and a traffic type T(k)=‘1’ is outputted if the protocol is UDP and a traffic type T(k)=‘0’ is outputted if the protocol is TCP, and if the UDP datagram which is encapsulated in IP datagram uses RTP, a sequence number area in a RTP header thereof is read and a sequence number is outputted as SQN(k), and if the IP datagram uses TCP, a sequence number area in a TCP header thereof is read and a sequence number is outputted as SQN(k).

11. A communication program for an IP network for prompting a computer, constituting a communication device which performs demodulation processing of a radio signal from a user side radio terminal and transfer processing of an IP datagram demodulated to the IP network, to execute functions of:
determining and outputting a user traffic sequence number k from an IP header area of an IP datagram received from the user side radio terminal, determining a protocol of a transport layer encapsulated on the IP datagram, and if the protocol is UDP, outputting a traffic type T(k)=‘1’, and if the protocol is TCP, outputting a traffic type T(k)=0;
calculating an IP datagram loss rate L(k) of the user traffic sequence k at a constant cycle by using a sequence number SQN(k) which is transmitted by using a radio header from a user terminal and is incremented by one for each IP datagram of a same user traffic sequence;
by using information of the L(k) and the T(k), outputting a signal D(k)=“01” if the loss rate L(k) is not less than a threshold TH1(k) set in advance and outputting a signal D(k)=“00” if the loss rate L(k) is less than the threshold TH1(k), when the user traffic sequence k inputted is traffic using UDP (T(k)=‘1’); and
passing the IP datagram of the user traffic sequence k if the signal D(k) is “00”, but discarding the IP datagram if the D(k) is “01”.

12. The communication program for the IP network, as claimed in claim 11, for prompting the computer to count a number of IP datagrams discarded since the signal D(k)=“01” is received, for each user traffic sequence.

13. The communication program for the IP network, as claimed in claim 11, for prompting the computer to execute functions of:
outputting a signal D(k)=“00” if the loss rate L(k) is not less than a threshold TH0(k) set in advance and outputting a signal D(k)=“10” if the loss rate L(k) is less than the threshold TH0(k), when the user traffic sequence k inputted is traffic using TCP (T(k)=‘0’), and if the signal D(k) is “10”, straightly passing the IP datagram of the user traffic sequence k or passing the IP datagram after performing marking in an IP header area thereof, in which whether the IP datagram is passed straightly or marking is performed is set in advance.

14. The communication program for the IP network, as claimed in claim 13, for prompting the computer to execute a function of counting a number of IP datagrams discarded since the signal D(k)=“01” is received, and a number of IP datagrams passed or passed after marking is performed since the signals D(k)=“00” and D(k)=“10” are received, for each user traffic sequence.

15. The communication program for the IP network, as claimed in claim 11, for prompting the computer to execute functions of:
determining and outputting a user traffic sequence number k from an IP header area of the IP datagram received from the user side radio terminal; determining a protocol of a transport layer encapsulated on the IP datagram and outputting a traffic type T(k)=‘1’ if the protocol is UDP and outputting a traffic type T(k)=‘0’ if the protocol is TCP; and if the IP datagram uses RTP, reading a sequence number area in an RTP header thereof and outputting a sequence number as SQN(k), and if the IP datagram uses TCP, reading a sequence number area in a TCP header thereof and outputting a sequence number as SQN(k).
